(19) United States
(12) Patent Application Publication
(10) Pub. No.: US 2014/0376877 A1
(43) Pub. Date: Dec. 25, 2014

(54) INFORMATION PROCESSING APPARATUS, INFORMATION PROCESSING METHOD AND PROGRAM

(71) Applicant: SONY CORPORATION, Tokyo (JP)

(72) Inventor: TAKASHI NOZAKI, Kanagawa (JP)

(21) Appl. No.: 14/299,879

(22) Filed: Jun. 9, 2014

(30) Foreign Application Priority Data
Jun. 19, 2013 (JP) 2013-128443

(51) Int. Cl. G11B 27/11; H04N 5/775; G11B 31/00; H04N 5/915

(52) U.S. Cl. CPC G11B 27/11; H04N 5/915; H04N 5/775; G11B 31/006
USPC 386/230; 386/326; 386/291

(57) ABSTRACT

There is provided an information processing apparatus including a recording control unit that changes time intervals of frame images in a process target image, the frame images being to be recorded, on the basis of detection results of events corresponding to the frame images, which are images corresponding to respective frames of the process target image, which is a moving image generated by imaging.

### CROSS REFERENCE TO RELATED APPLICATIONS

This application claims the benefit of Japanese Priority Patent Application JP 2013-128443 filed Jun. 19, 2013, the entire contents of which are incorporated herein by reference.

### BACKGROUND

The present disclosure relates to an information processing apparatus, an information processing method, and a program.

Imaging apparatuses intended for causing a recording of a moving image (or a plurality of still images. This applies also below) for a long time by continuously capturing images such as life log cameras, action cameras for sports, and drive recorders are in widespread use. If images are captured for a long time in high resolution by an imaging apparatus as described above, a recording medium needs a large storage capacity to store a moving image obtained by imaging.

In the meantime, technologies to reduce the amount of information of a moving image generated by imaging have been developed. As a technology to reduce the amount of information of a moving image generated by imaging, for example, a technology that uses, just like the technology described in JP H05-183858A, Time Lapse (also called time-lapse imaging, crawling imaging, or fixed interval imaging) that causes an image corresponding to each frame (hereinafter, referred to as a “frame image”) of a moving image to be recorded at fixed time intervals can be cited.

### SUMMARY

When recording a moving image generated by imaging, the number of frame images to be recorded is reduced by using, for example, Time Lapse. Thus, when, for example, Time Lapse is used to record a moving image generated by imaging, the amount of information of images to be recorded can be reduced.

However, even if, for example, Time Lapse is used to record a moving image generated by imaging, for example, problems as described below could arise:

If the frame interval (which can be grasped as, for example, the imaging interval) for images caused to be recorded is made wider, the amount of information of images to be recorded decreases, but it becomes more difficult to understand links between images in the recorded images. In addition, scenes could be skipped too much due to losses of continuity of images and so the recorded images could be hard for the user to view.

If the frame interval for images caused to be recorded is made narrower, the amount of information of images to be recorded increases and thus, a larger recording medium is needed to record the images or imaging for a long time becomes difficult. Also if the frame interval for images caused to be recorded is made narrower, continuity of images in the recorded images is maintained and thus, the probability that the user viewing the images feels a sense of discomfort in joints of scenes decreases, but most scenes become monotonous and thus, returning to view the recorded images could become a great burden for the user.

The present disclosure proposes a novel and improved information processing apparatus capable of causing a recording medium to record easier-to-view images while reducing the amount of information of a moving image generated by imaging, an information processing method, and a program.

According to an embodiment of the present disclosure, there is provided an information processing apparatus including a recording control unit that changes time intervals of frame images in a process target image, the frame images being to be recorded, on the basis of detection results of events corresponding to the frame images, which are images corresponding to respective frames of the process target image, which is a moving image generated by imaging.

According to an embodiment of the present disclosure, there is provided an information processing method including changing time intervals of frame images in a process target image, the frame images being to be recorded, on the basis of detection results of events corresponding to the frame images, which are images corresponding to respective frames of the process target image, which is a moving image generated by imaging.

According to an embodiment of the present disclosure, there is provided a program for causing a computer to execute changing time intervals of frame images in a process target image, the frame images being to be recorded, on the basis of detection results of events corresponding to the frame images, which are images corresponding to respective frames of the process target image, which is a moving image generated by imaging.

According to the present disclosure, a recording medium can be caused to record easier-to-view images while the amount of information of a moving image generated by imaging being reduced.

### BRIEF DESCRIPTION OF THE DRAWINGS

FIG. 1 is an explanatory view showing an example of an imaging device according to the present embodiment capable of generating an image to be processed according to the present embodiment;

FIG. 2 is an explanatory view showing another example of the imaging device according to the present embodiment capable of generating an image to be processed according to the present embodiment;

FIG. 3 is an explanatory view showing still another example of the imaging device according to the present embodiment capable of generating an image to be processed according to the present embodiment;

FIG. 4 is an explanatory view showing an overview when an information processing apparatus according to the present embodiment processes an image to be processed captured by an external imaging device;

FIG. 5 is an explanatory view illustrating processing related to an information processing method according to the present embodiment;

FIG. 6 is an explanatory view showing an example of association information according to the present embodiment;

FIG. 7 is an explanatory view illustrating processing related to the information processing method according to the present embodiment;

FIG. 8 is an explanatory view illustrating processing related to the information processing method according to the present embodiment;

FIG. 9 is an explanatory view illustrating processing related to the information processing method according to the present embodiment;

FIG. 10 is an explanatory view illustrating processing related to the information processing method according to the present embodiment;

FIG. 11 is a flow chart showing an example of processing related to the information processing method according to the present embodiment;

FIG. 12 is a block diagram showing the configuration of the information processing apparatus according to the present embodiment; and

FIG. 13 is an explanatory view showing an example of a hardware configuration of the information processing apparatus according to the present embodiment.

### DETAILED DESCRIPTION OF THE EMBODIMENT

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Hereinafter, the description will be provided in the order shown below:

1. Information Processing Method According to the Present Embodiment

2. Information Processing Apparatus According to the Present Embodiment

3. Program According to the Present Embodiment

(Information Processing Method According to the Present Embodiment)

Before an information processing apparatus according to the present embodiment is described, an information processing method according to the present embodiment will first be described. The information processing method according to the present embodiment will be described below by citing processing related to the information processing method according to the present embodiment performed by the information processing apparatus according to the present embodiment.

Overview of Processing Related to Information Processing Method According to the Present Embodiment

When, as described above, existing Time Lapse causing a recording of a frame image of a moving image generated by imaging at fixed time intervals is used, it is not to be desired to cause easier-to-view images to be recorded while the amount of information of a moving image generated by imaging being reduced.

Thus, as processing related to the information processing method according to the present embodiment, the information processing apparatus according to the present embodiment attempts to achieve both of reducing the amount of information of a moving image generated by imaging and causing a recording medium to record easier-to-view images by performing, for example, (1) recording control processing described below.

(1) Recording Control Processing

Instead of causing a recording medium to record a frame image of a moving image generated by imaging (hereinafter, called “process target image”) at fixed time intervals, the information processing apparatus according to the present embodiment changes time intervals of frame images a recording medium is caused to record of a process target image. The method of recording images by the recording control processing according to the present embodiment may be referred to as “Variable Time Lapse” below in comparison with existing Time Lapse.

More specifically, the information processing apparatus according to the present embodiment changes time intervals between frame images a recording medium is caused to record of a process target image based on detection results of an event corresponding to a frame image corresponding to each frame of a process target image.

As a process target image according to the present embodiment, for example, a moving image generated by imaging using an imaging device constituting an imaging unit (described later) included in the information processing apparatus according to the present embodiment or by imaging using an imaging device constituting an external imaging unit of the information processing apparatus according to the present embodiment can be cited.

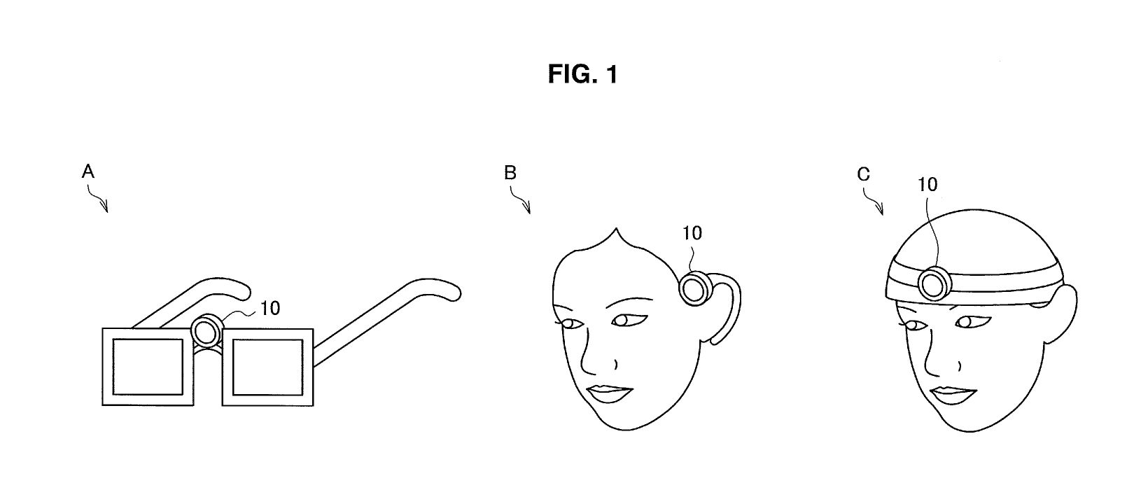

FIG. 1 is an explanatory view showing an example of an imaging device 10 according to the present embodiment capable of generating an image to be processed according to the present embodiment.

As imaging devices according to the present embodiment, for example, an imaging device (A in FIG. 1) mounted on wearable glasses, an imaging device (B in FIG. 1) mounted on a wearable headset, and an imaging device (C in FIG. 1) mounted on a wearable helmet can be cited. When the imaging device according to the present embodiment is, for example, an imaging device mounted on a wearable device as shown in A to C of FIG. 1, the direction in which an image is captured by the imaging device according to the present embodiment matches, for example, the direction of the line of sight of the user wearing the wearable device.

The imaging device 10 according to the present embodiment includes, for example, a lens/image sensor and a signal processing circuit. The lens/image sensor is configured by, for example, an optical lens and an image sensor using a plurality of image sensor such as CMOS (Complementary Metal Oxide Semiconductor). The signal processing circuit includes, for example, an AGC (Automatic Gain Control) circuit and ADC (Analog to Digital Converter) to convert an analog signal generated by the image sensor into a digital signal (image data) and perform various kinds of signal processing thereon. The signal processing performed by the signal processing circuit includes, for example, White Balance correction processing, color tone correction processing, gamma correction processing, YCbCr conversion processing, and edge enhancement processing.

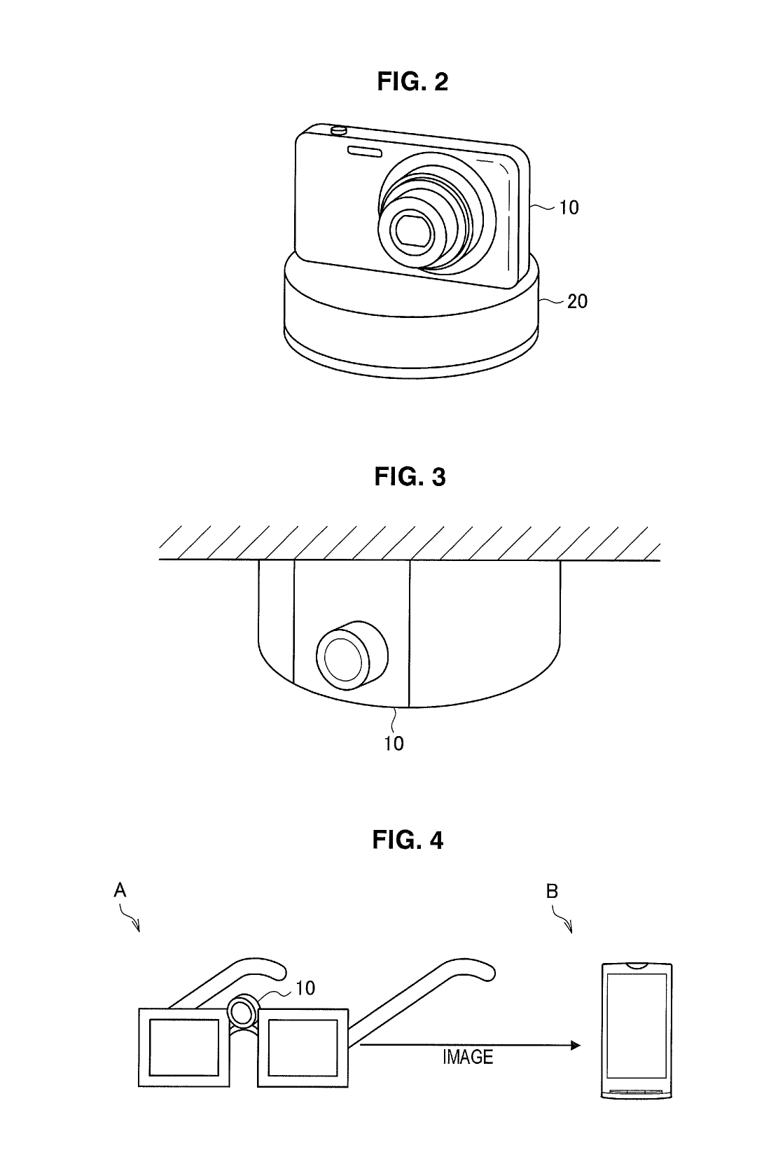

However, the imaging device according to the present embodiment is not limited to imaging devices mounted on wearable devices. FIGS. 2 and 3 are explanatory views showing other examples of the imaging device 10 according to the present embodiment capable of generating an image to be processed according to the present embodiment.

The imaging device 10 according to the present embodiment may be mounted on, for example, as shown in FIG. 2, a pan head 20. If the pan head 20 shown in FIG. 2 is an auto-rotating pan head that rotates automatically, a so-called party shot to which Variable Time Lapse is applied can be realized by the recording control processing according to the present embodiment being applied to the process target image captured by the imaging device 10 while the pan head 120 automatically rotates. Incidentally, an existing party shot is, for example, a shot captured by an imaging device at fixed time intervals or when some event occurs (for example, when a smiling face is detected) while the pan head automatically rotates.

The imaging device 10 according to the present embodiment may be, for example, as shown in FIG. 3, an imaging device provided in a building, for example, a security camera mounted on a ceiling surface or wall surface.

The imaging device according to the present embodiment capable of generating an image to be processed according to the present embodiment includes, for example, the imaging devices shown in FIGS. 1 to 3. However, it is needless to say that the imaging device according to the present embodiment is not limited to examples shown in FIGS. 1 to 3.

Also, as the imaging device according to the present embodiment, an imaging device constituting an imaging unit (described later) included in an information processing apparatus according to the present embodiment can be cited. If the imaging device according to the present embodiment is an imaging device constituting an imaging unit (described later) included in an information processing apparatus according to the present embodiment, the information processing apparatus according to the present embodiment can process an image to be processed captured by the imaging device constituting the imaging unit (described later).

However, the imaging device according to the present embodiment is not limited to the above examples. For example, the imaging device according to the present embodiment may be an external imaging device of an information processing apparatus according to the present embodiment. If the imaging device according to the present embodiment is an external imaging device of an information processing apparatus according to the present embodiment, when, for example, an image to be processed captured by the external imaging device is acquired from the external imaging device, the information processing apparatus according to the present embodiment processes the acquired image to be processed.

FIG. 4 is an explanatory view showing an overview when an information processing apparatus according to the present embodiment processes an image to be processed captured by an external imaging device. A shown in FIG. 4 shows an example of the imaging device 10 according to the present embodiment and shows an imaging device mounted on wearable glasses shown in A of FIG. 1. B shown in FIG. 4 shows an example of the information processing apparatus according to the present embodiment. While FIG. 4 shows a communication apparatus such as a smartphone or a mobile phone as the information processing apparatus according to the present embodiment, it is needless to say that the information processing apparatus according to the present embodiment is not limited to the communication apparatus. If, for example, as shown in FIG. 4, the imaging device according to the present embodiment is an external imaging device of an information processing apparatus according to the present embodiment, the information processing apparatus according to the present embodiment processes, for example, an image to be processed acquired from the external imaging device.

The information processing apparatus according to the present embodiment processes the process target image generated by imaging using the imaging devices according to the present embodiment as shown, for example, in FIGS. 1 to 4.

However, the process target image according to the present embodiment is not limited to the above examples. For example, the process target image according to the present embodiment may be a moving image generated by imaging using an imaging unit (described later) and stored in a recording medium. If the process target image according to the present embodiment is a moving image stored in a recording medium, an information processing apparatus according to the present embodiment processes a moving image read from the recording medium as the process target image.

As the recording medium caused by an information processing apparatus according to the present embodiment to record images by recording control processing according to the present embodiment, for example, a storage unit (described later) included in the information processing apparatus according to the present embodiment, an external recording medium connected to the information processing apparatus according to the present embodiment, and a recording medium included in an external apparatus capable of communicating with the information processing apparatus according to the present embodiment can be cited.

Detection processing related to detection of an event corresponding to a frame image is performed by, for example, a detection unit (described later) included in an information processing apparatus according to the present embodiment or an external apparatus. An example of the detection processing according to the present embodiment will be described later.

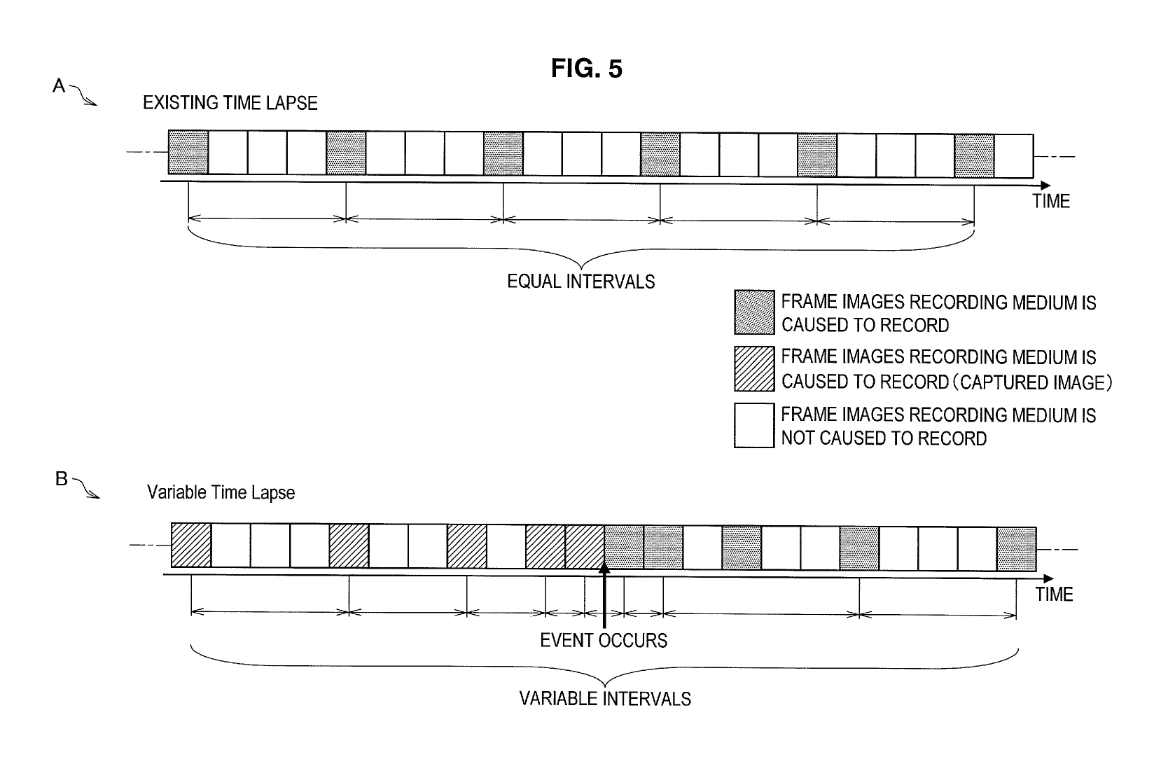

FIG. 5 is an explanatory view illustrating processing related to an information processing method according to the present embodiment and shows examples of a frame image recorded by recording control processing according to the present embodiment. A shown in FIG. 5 shows an example of the frame image recorded by existing Time Lapse. B shown in FIG. 5 shows an example of the frame image recorded by Variable Time Lapse realized by recording control processing according to the present embodiment.

When, as shown in A of FIG. 5, existing Time Lapse is used, frame images are recorded at equal time intervals. In Variable Time Lapse, by contrast, time intervals between frame images a recording medium is caused to record can be made, as shown in B of FIG. 5, variable intervals, instead of equal intervals, by the recording control processing according to the present embodiment. An example of the recording control processing according to the present embodiment will be described later.

In Variable Time Lapse realized by the recording control processing according to the present embodiment, just like when existing Time Lapse shown in, for example, A of FIG. 5, is used, frame images corresponding to a portion of frames of the process target image are recorded in a recording medium. Thus, the amount of information of a moving image (process target image) generated by imaging can be reduced by recording control processing according to the present embodiment being performed by an information processing apparatus according to the present embodiment.

In Variable Time Lapse realized by recording control processing according to the present embodiment, as shown in, for example, B of FIG. 5, time intervals between frame images a recording medium is caused to record can be made variable intervals. Thus, the information processing apparatus according to the present embodiment can make images recorded by Variable Time Lapse images in which images corresponding to a time around the time at which an event is detected are enhanced in the time direction. Thus, images recorded by Variable Time Lapse become images that are, for example, well-defined and easier to view.

Therefore, a recording medium can be caused to record easier-to-view images while the amount of information of a moving image generated by imaging being reduced by recording control processing according to the present embodiment being performed by an information processing apparatus according to the present embodiment as processing related to an information processing method according to the present embodiment.

Also, a recording medium can be caused to record easier-to-view images while the amount of information of a moving image generated by imaging being reduced by processing related to an information processing method according to the present embodiment and therefore, the information processing method according to the present embodiment can be said to be suitable for application when, for example, a user looking at recorded images views look-back images for life logs or images captured by security cameras are monitored. However, it is needless to say that application examples of the information processing method according to the present embodiment are not limited to application examples when a user looking at recorded images views look-back images for life logs and images captured by security cameras are monitored.

The recording control processing according to the present embodiment will be described more concretely below.

An information processing apparatus according to the present embodiment decides a recording time at which a recording medium is caused to record a frame image of the process target image using a time at which a corresponding event is detected in the process target image as a reference time.

More specifically, an information processing apparatus according to the present embodiment decides the recording time based on, for example, association information in which the actual time relative to the reference time and the recording time are associated. Hereinafter, the recording time may be shown as “t′”.

As the association information according to the present embodiment, for example, data indicating a function t′=f(t) that uniquely decides the recording time t′ by accepting time t represented relative to the reference time as input.

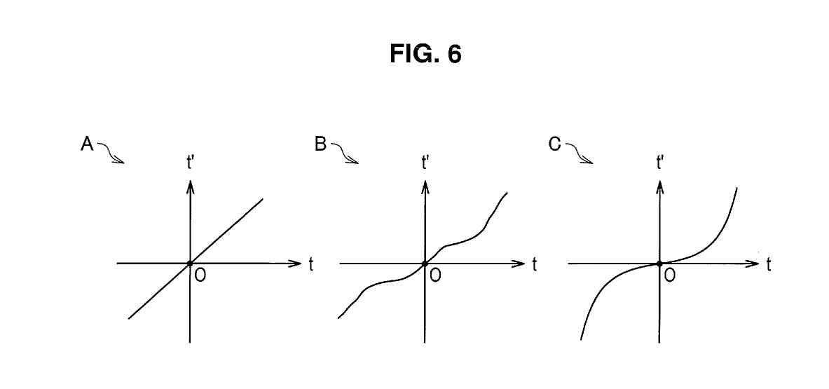

FIG. 6 is an explanatory view showing an example of association information according to the present embodiment. Each of A to C shown in FIG. 6 shows an example of the function t′=f(t). In FIG. 6, the horizontal axis shows time t represented by setting an origin O (reference) as the reference time. Also in FIG. 6, the vertical axis shows the recording time t′. However, the function t′=f(t) playing the role of association information according to the present embodiment is not limited to the examples shown in A to C of FIG. 6. As the function t′=f(t) playing the role of association information according to the present embodiment, any function capable of uniquely deciding the recording time t′ by accepting time t represented relative to the reference time as input can be cited.

An information processing apparatus according to the present embodiment decides the recording time t′ by using, for example, the preset function t′=f(t) or the function t′=f(t) set by a user's operation.

By the recording time t′ being decided by an information processing apparatus according to the present embodiment using the set function t′=f(t), like a case when, for example, the function shown in C of FIG. 6 is used, various recording times can be decided such as a case when recording intervals of frame images (time interval between the time at which an event occurs and the recording time t′) increase with an increasing time interval from the time at which an event occurs. Thus, by the recording time t′ being decided by the information processing apparatus according to the present embodiment using the set function t′=f(t), as shown in, for example, B of FIG. 5, time intervals of frame images a recording medium is caused to record can be made variable intervals.

However, the association information according to the present embodiment is not limited to the function t′=f(t). For example, the association information according to the present embodiment may be a table or database in which time t represented relative to the reference time and the recording time t′ are associated in a one-to-one correspondence. When the association information according to the present embodiment is the table or the database, like a case when the set function t′=f(t) is used, the information processing apparatus according to the present embodiment can make, for example, time intervals of frame images a recording medium is caused to record variable intervals.

If the recording time is decided, the information processing apparatus according to the present embodiment causes a recording medium to record the frame image corresponding to the decided recording time. The information processing apparatus according to the present embodiment causes a recording medium to record the frame image corresponding to the decided recording time by, for example, transmitting a control signal including the frame number of the frame corresponding to the decided recording time and a recording instruction of image to the recording medium or an external apparatus including the recording medium. Incidentally, the information processing apparatus according to the present embodiment may further transmit, for example, data showing the process target image or data showing frame images to the recording medium or an external apparatus including the recording medium.

The information processing apparatus according to the present embodiment decides the recording time based on association information according to the present embodiment, for example, as described above, in recording control processing according to the present embodiment and causes the recording medium to record the frame image corresponding to the decided recording time in the process target image. Therefore, Variable Time Lapse as shown in, for example, B of FIG. 5 is realized.

The processing related to the information processing method according to the present embodiment is not limited to the above processing (recording control processing) in (1). For example, the information processing apparatus according to the present embodiment can further perform one or two or more pieces of processing of (2) image processing, (3) detection processing, and (4) display control processing shown below as processing related to the information processing method according to the present embodiment. One or two or more pieces of processing of (2) image processing, (3) detection processing, and (4) display control processing shown below can also be performed by, for example, an external apparatus of the information processing apparatus according to the present embodiment.

(2) Image Processing

An information processing apparatus according to the present embodiment generates, for example, processed images in which a portion of frame images corresponding to a time at which an event is detected is represented by a moving image based on, for example, frame images (frame images corresponding to the recording time decided by the above processing (recording control processing) in (1)) a recording medium is caused to record of the process target image. Images in which a portion thereof is represented by a moving image like processed images according to the present embodiment are called “Cinemagraph images” or “Cinemagraph”. Hereinafter, processed images according to the present embodiment may be shown as “Cinemagraph”.

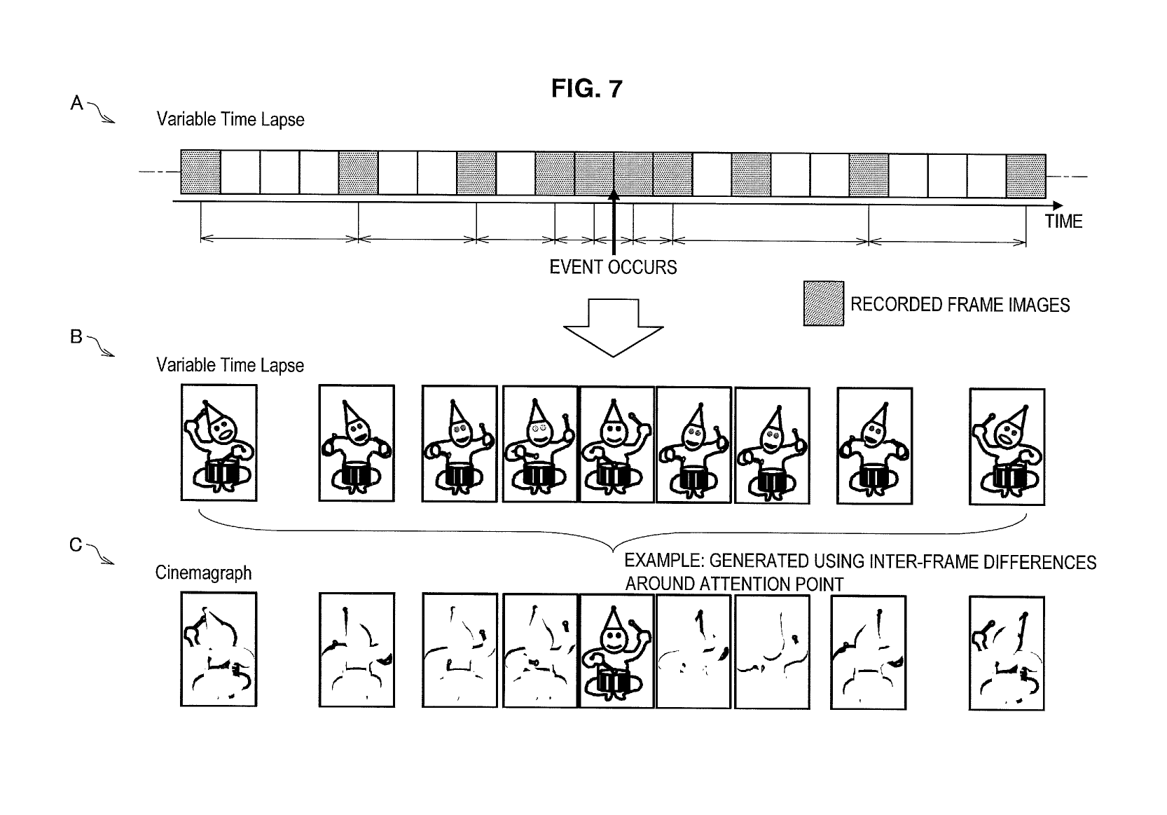

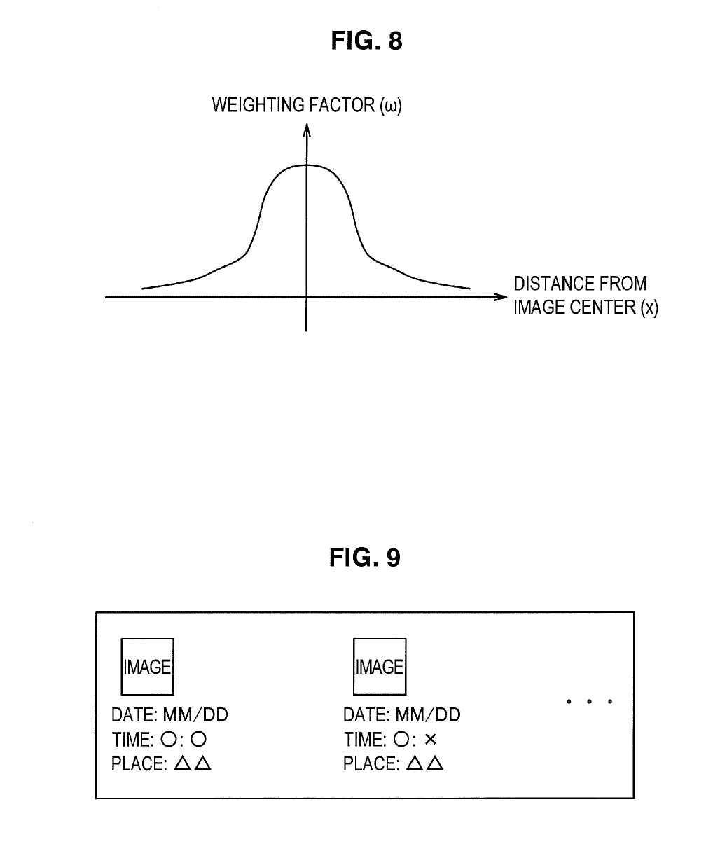

FIGS. 7 and 8 are explanatory views illustrating processing related to the information processing method according to the present embodiment. FIG. 7 shows an overview of image processing according to the present embodiment and FIG. 8 shows an example of the image processing according to the present embodiment. A shown in FIG. 7 shows an example of the frame corresponding to the recording time decided by the above processing (recording control processing) in (1). B shown in FIG. 7 shows an example of frame images of frames corresponding to the decided recording time shown in A of FIG. 7. C shown in FIG. 7 shows an overview of image processing according to the present embodiment performed based on frame images shown in B of FIG. 7.

The information processing apparatus according to the present embodiment identifies an attention point in a frame image (hereinafter, may be shown as a “reference frame image”) corresponding to the time at which, for example, an event is detected.

At the attention point according to the present embodiment, for example, the center point of an image can be cited. However, the attention point according to the present embodiment is not limited to the above example. When, for example, like the imaging device 10 shown in FIG. 1, the direction in which an imaging device according to the present embodiment captures an image and the direction of the line of sight of a user wearing a wearable device match, the point the user focuses on in an image identified by using the eye tracking technology the like can be set as the attention point according to the present embodiment. Hereinafter, a case in which the attention point according to the present embodiment is the center point of an image is taken as an example.

After the attention point is identified, the information processing apparatus according to the present embodiment generates processed images according to the present embodiment by using, for example, inter-frame differences of a region around the attention point between the reference frame image and other frame images corresponding to the decided recording time.

More specifically, the information processing apparatus according to the present embodiment generates processed images according to the present embodiment by, for example, multiplying the image difference value by a coefficient based on the Gaussian function as shown in FIG. 8 in accordance with the distance from the attention point relative to the reference frame image.

However, the image processing according to the present embodiment is not limited to the above example.

For example, the information processing apparatus according to the present embodiment can generate processed image according to the present embodiment by using simple image differences relative to the reference frame image or a motion vector relative to the reference frame image. Also, the information processing apparatus according to the present embodiment can generate processed image according to the present embodiment by using, for example, any technology capable of generating Cinemagraph images.

The information processing apparatus according to the present embodiment generates processed images according to the present embodiment by performing the above processing as the image processing according to the present embodiment.

When processed images according to the present embodiment are generated by the image processing according to the present embodiment, the information processing apparatus according to the present embodiment causes a recording medium to record, for example, processed images according to the present embodiment in the above processing (recording control processing) in (1), instead of the reference frame image (frame image corresponding to the time at which an event is detected). Also in the above case, the information processing apparatus according to the present embodiment may cause a recording medium to record processed images according to the present embodiment in the above processing (recording control processing) in (1) together with the reference frame image.

Processed images according to the present embodiment generated by image processing according to the present embodiment are images in which a portion of frame images corresponding to the time at which an event is detected is a moving image. That is, processed images according to the present embodiment can be said to be images in which frame images corresponding to around the time at which an event is detected are enhanced in the space direction.

Therefore, images recorded by Variable Time Lapse by an information processing apparatus according to the present embodiment causing a recording medium to record, for example, processed images according to the present embodiment generated by image processing according to the present embodiment together with the reference frame image, instead of the reference frame image (frame image corresponding to the time at which an event is detected), in the above processing (recording control processing) in (1) become images that are well-defined and easier to view with images corresponding to a time around the time at which, for example, an event is detected being enhanced in the time direction and the space direction.

(3) Detection Processing

An information processing apparatus according to the present embodiment detects a corresponding event in the process target image according to the present embodiment. An information processing apparatus according to the present embodiment detects a corresponding event in the process target image according to the present embodiment based on, for example, information (data) corresponding to the process target image according to the present embodiment or the process target image according to the present embodiment.

(3-1) First Example of Detection Processing: Example of Detection Processing Based on Information Corresponding to the Process Target Image According to the Present Embodiment

When an imaging device according to the present embodiment is an imaging device like, for example, the imaging device 10 shown in FIG. 1, in which the direction in which the imaging device according to the present embodiment captures an image and the direction of the line of sight of a user wearing a wearable device match, an information processing apparatus according to the present embodiment acquires, for example, detection data showing detection results of a motion detection sensor mounted on an imaging device (or a wearable device) according to the present embodiment. Then, the information processing apparatus according to the present embodiment determines that an event has occurred when, for example, a change of the angular velocity or acceleration indicated by detection data in a set predetermined time is equal to or less than a set threshold (or the change is less than the threshold and this also applies below).

As the motion detection sensor according to the present embodiment, for example, a gyro sensor and an acceleration sensor can be cited. If an imaging device according to the present embodiment is an imaging device like, for example, the imaging device 10 shown in FIG. 1, detection data according to the present embodiment corresponds to, for example, posture information showing the posture of a user head.

Also when a change of the angular velocity or acceleration indicated by detection data is equal to or less than the set threshold, it is probable that the user observes some object closely. Thus, in the detection processing according to the first example, the information processing apparatus according to the present embodiment determines that an event has occurred when a change of the angular velocity or acceleration indicated by detection data is equal to or less than the set threshold.

(3-2) Second Example of Detection Processing: Another Example of Detection Processing Based on Information Corresponding to the Process Target Image According to the Present Embodiment

An information processing apparatus according to the present embodiment acquires, for example, audio data indicating detection results of a microphone mounted on an imaging device according to the present embodiment (or an external apparatus on which an imaging device such as a wearable device is mounted). Then, the information processing apparatus according to the present embodiment determines that an event has occurred when, for example, the loudness of sound indicated by the audio data or a change of sound indicated by the audio data in a set predetermined time is equal to or more than a set threshold (or the loudness or the change is larger than the threshold and this also applies below).

(3-3) Third Example of Detection Processing: Example of Detection Processing Based on the Process Target Image According to the Present Embodiment

An information processing apparatus according to the present embodiment detects, for example, a predetermined object from the process target image according to the present embodiment and determines that an event has occurred when the predetermined object is detected. The object according to the present embodiment includes, for example, a person and a thing. The information processing apparatus according to the present embodiment may also detect, for example, a specific expression (for example, a smiling face, a tearful face and the like) of a person to determine that an event has occurred when the specific expression is detected.

If the detection processing according to the third example is performed when an imaging device according to the present embodiment is the imaging device 10 shown in FIG. 2, for example, a party shot in which detection of a specific expression such as a smiling face or a specific person is an event and to which Variable Time Lapse is applied is realized. If the detection processing according to the third example is performed when an imaging device according to the present embodiment is the imaging device 10 shown in FIG. 3, for example, Variable Time Lapse in which detection of a suspicious substance or a suspicious person is an event is realized.

(3-4) Fourth Example of Detection Processing

An information processing apparatus according to the present embodiment can also perform, for example, processing combining two pieces or more of the detection processing according to the first example shown in (3-1) to the detection processing according to the third example shown in (3-3) as detection processing according to the present embodiment.

The information processing apparatus according to the present embodiment performs, for example, the detection processing according to the first example shown in (3-1) to the detection processing according to the fourth example shown in (3-4) as detection processing according to the present embodiment. Incidentally, it is needless to say that the detection processing according to the present embodiment is not limited to the detection processing according to the first example shown in (3-1) to the detection processing according to the fourth example shown in (3-4).

When an event is detected by detection processing according to the present embodiment, the information processing apparatus according to the present embodiment performs, for example, the processing (recording control processing) in (1) based on detection results of events detected by the detection processing according to the present embodiment. That is, in the above case, the information processing apparatus according to the present embodiment changes time intervals of frame images a recording medium is caused to record of the process target image according to the present embodiment based on, for example, detection results of events detected by the detection processing according to the present embodiment.

(4) Display Control Processing

An information processing apparatus according to the present embodiment causes a display screen to display images (frame images or processed images according to the present embodiment) recorded by the processing (recording control processing) in (1) or a screen related to the images. As the display screen in which images are displayed by display control processing according to the present embodiment, for example, the display screen of a display unit (described later) included in the information processing apparatus according to the present embodiment, the display screen of an external display device connected to the information processing apparatus according to the present embodiment, and a display device included in an external apparatus capable of communicating with the information processing apparatus according to the present embodiment can be cited.

(4-1) First Example of Display Control Processing

An information processing apparatus according to the present embodiment causes the display screen to display, for example, the time at which an event in the process target image according to the present embodiment is detected and frame images when the event is detected by associating the time and the frame images.

If processed images (Cinemagraph) according to the present embodiment generated by the processing (image processing) in (2) are recorded in the processing (recording control processing) in (1), instead of the reference frame image (frame image corresponding to the time at which an event is detected), the information processing apparatus according to the present embodiment may cause the display screen to display, for example, the time at which an event is detected and processed images according to the present embodiment corresponding to the time at which the event is detected by associating the time and the processed images.

FIG. 9 is an explanatory view illustrating processing related to the information processing method according to the present embodiment and shows an example of the screen displayed in the display screen by the display control processing according to the first example.

The information processing apparatus according to the present embodiment causes the display screen to display, as shown in, for example, FIG. 9, images (frame images or processed images according to the present embodiment) corresponding to the time at which an event is detected as a list using the time at which an event is detected as an index.

Also, the information processing apparatus according to the present embodiment may cause the display screen to display, like, for example, “place” shown in FIG. 9, the position where frame images corresponding to the time at which an event is detected are captured and images (frame images or processed images according to the present embodiment) by associating the position and the images. The position where the frame images are captured is detected by, for example, a position detection device included in an imaging device according to the present embodiment (or an external apparatus connected to an imaging device according to the present embodiment). The information processing apparatus according to the present embodiment causes the display screen to display the position where frame images are captured and the frame images by associating the position and the frame images using position information showing detection results by the position detection device.

When the time at which an event is detected as an index and processed images according to the present embodiment corresponding to the time at which the event is detected are displayed, a portion of the images is represented as a moving image. Thus, in contrast to the simple arrangement of images or the simple arrangement of video, displayed processed images according to the present embodiment attract attention by being more conspicuous in the display of the above case and thus, the display is easier to view than a general listing.

(4-2) Second Example of Display Control Processing

An information processing apparatus according to the present embodiment changes the playback speed of recorded frame images based on, for example, a user's operation.

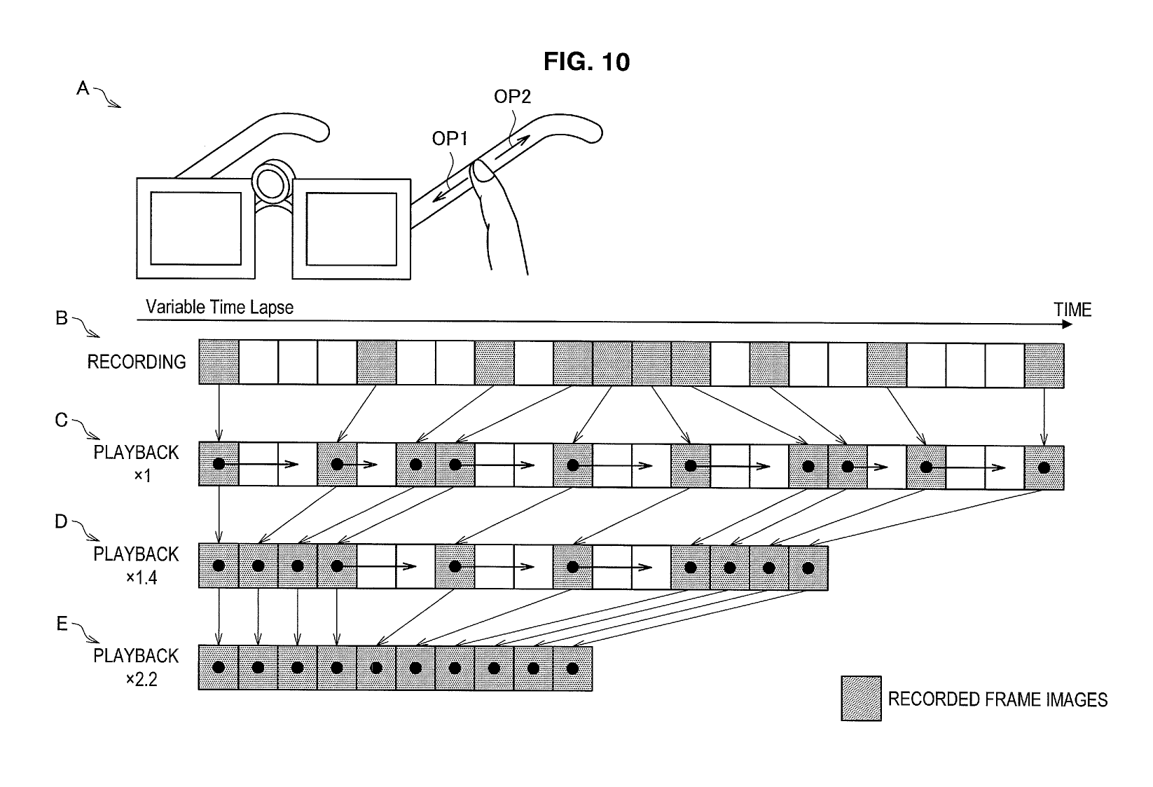

FIG. 10 is an explanatory view illustrating processing related to the information processing method according to the present embodiment and shows an overview of the display control processing according to the second example.

A shown in FIG. 10 shows an example of the user's operation as a trigger of the display control processing according to the second example. Here, A in FIG. 10 shows an example in which the user operates an operation device provided in a wearable device on which the imaging device 10 shown in A of FIG. 1. In A shown in FIGS. 10, OP1 and OP2 show an example of the user's operation.

B shown in FIG. 10 shows an example of frame images recorded by the processing (recording control processing) in (1). Each of C to E shown in FIG. 10 shows an example of playback of frame images realized by the display control processing according to the second example. It is needless to say that examples of playback of frame images realized by the display control processing according to the second example are not limited to C to E shown in FIG. 10.

When, for example, an operation signal corresponding to the user's operation shown in OP1 or OP2 shown in A of FIG. 10 is detected, the information processing apparatus according to the present embodiment changes the playback speed of recorded frame images, for example, among C to E shown in FIG. 10 in accordance with the detected operation signal. Here, the information processing apparatus according to the present embodiment changes the playback speed of recorded frame images, for example, among C to E shown in FIG. 10 one step at a time. The information processing apparatus according to the present embodiment may also change the playback speed of recorded frame images a plurality of steps at a time in accordance with, for example, the amount of operation indicated by the detected operation signal.

With the playback speed of recorded frame images being changed by the information processing apparatus according to the present embodiment based on a user's operation, for example, the convenience of users can further be enhanced.

Concrete Example of Processing Related to Information Processing Method According to the Present Embodiment.

Next, an example of the processing related to the information processing method according to the present embodiment will be described.

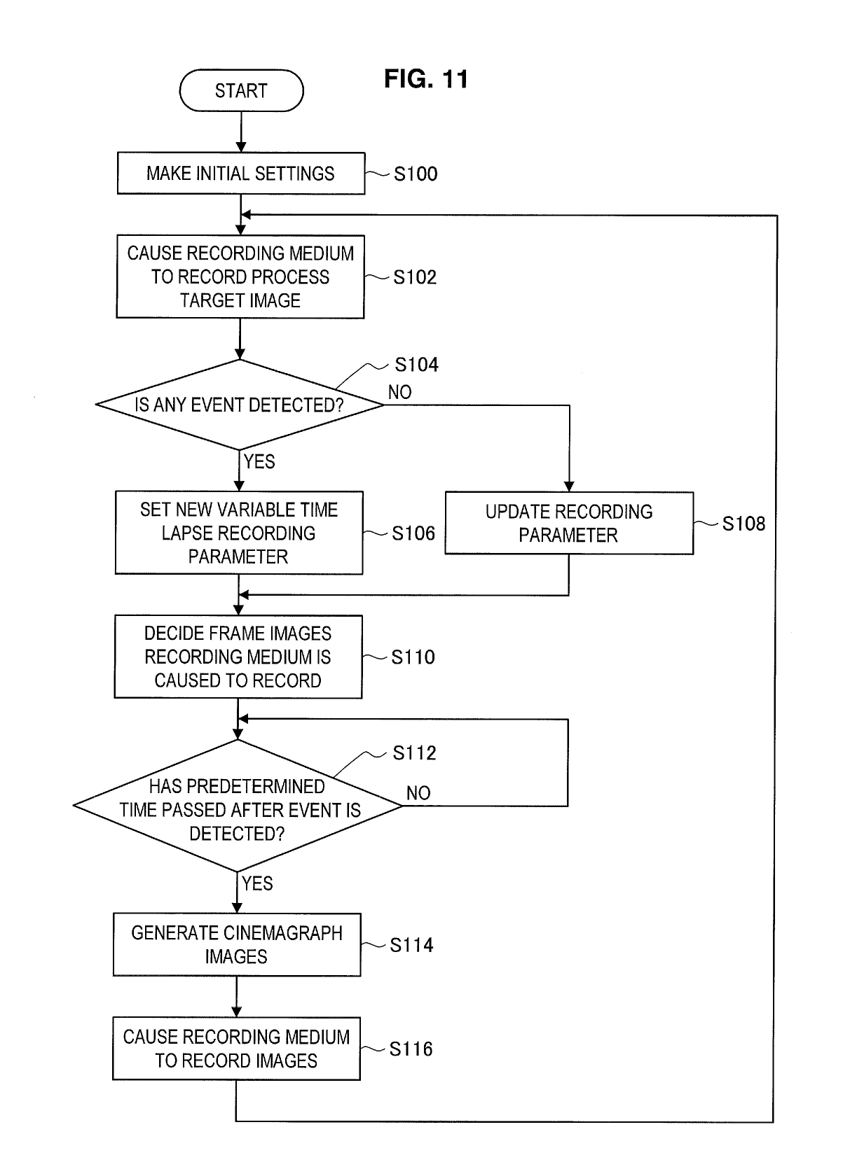

FIG. 11 is a flow chart showing an example of processing related to the information processing method according to the present embodiment. In FIG. 10, for example, processing in steps S106, S108, S110, and S116 corresponds to the processing (recording control processing) in (1). Also in FIG. 10, for example, processing in steps S112 and S114 corresponds to the processing (image processing) in (2).

The information processing apparatus according to the present embodiment makes initial settings (S100). In step S100, the information processing apparatus according to the present embodiment sets, for example, association information according to the present embodiment and sets parameters used for processing.

The information processing apparatus according to the present embodiment causes a recording medium to record the process target image according to the present embodiment (S102). The information processing apparatus according to the present embodiment records the process target image according to the present embodiment for a predetermined time in, for example, a ring buffer. The fixed time for which the process target image according to the present embodiment are recorded in step S102 depends on, for example, the capacity and settings of the ring buffer.

The information processing apparatus according to the present embodiment determines whether any event is detected (S104). The information processing apparatus according to the present embodiment makes the determination in step S104 based on a result of the processing (detection processing) in (3) that detects an event. As the processing (detection processing) in (3), for example, the processing according to the first example shown in (3-1) to the processing according to the fourth example shown in (3-4) can be cited.

The processing (detection processing) in (3) that detects an event may be performed by the information processing apparatus according to the present embodiment or an external apparatus. When, for example, the information processing apparatus according to the present embodiment performs the processing (detection processing) in (3), the information processing apparatus according to the present embodiment makes the determination in step S104 in accordance with the result of the processing (detection processing) in (3). When the processing (detection processing) in (3) is performed by, for example, an external apparatus, the information processing apparatus according to the present embodiment makes the determination in step S104 in accordance with the result of the processing (detection processing) in (3) acquired from the external apparatus.

If the determination that an event is detected is made in step S104, the information processing apparatus according to the present embodiment sets a new Variable Time Lapse recording parameter (S106). The information processing apparatus according to the present embodiment generates the new Variable Time Lapse recording parameter by using the time at which an event occurs as a reference. More specifically, the information processing apparatus according to the present embodiment sets, for example, a new function t′=f(t) (example of association information according to the present embodiment), decides the recording time t′ by using the set function t′=f(t), and sets the decided recording time t′ as the new Variable Time Lapse recording parameter.

Also if the determination that an event is detected is made in step S104, the information processing apparatus according to the present embodiment updates recording parameters (S108). For example, the information processing apparatus according to the present embodiment decides the recording time t′ corresponding to the actual time relative to the reference time by using the set function t′=f(t) and updates the recording parameter using the decided recording time t′.

When the processing in step S106 or the processing in step S108 is performed, the information processing apparatus according to the present embodiment decides the frame images the recording medium is caused to record (S110). The information processing apparatus according to the present embodiment decides frame images corresponding to the decided recording time t′ as frame images the recording medium is caused to record.

If the recording time t′ is a past time relative to the reference time, the information processing apparatus according to the present embodiment decides frame images corresponding to the recording time t′ among the process target images stored in the ring buffer for a fixed time as frame images the recording medium is caused to record. The information processing apparatus according to the present embodiment causes, for example, a RAM (Random Access Memory) to temporarily store frame images decided as frame images the recording medium is caused to record. The reason for causing, for example, the RAM to store the decided frame images is that the frame images may be used for generating Cinemagraph images by, for example, processing in step S114 described later.

After the processing in step S110 is performed, the information processing apparatus according to the present embodiment determines whether a predetermined time has passed after the time at which the event is detected (S112). The processing in step S112 corresponds to, for example, processing to generate an interval in which Cinemagraph images are generated. The predetermined time related to the processing in step S112 may be a fixed value set in advance or a variable value that can be set based on a user's operation or the like.

The predetermined time related to the processing in step S112 may also be adjusted based on, for example, detection data showing detection results of a motion detection sensor mounted on an imaging device (or a wearable device) according to the present embodiment. If the predetermined time is adjusted based on detection data, the information processing apparatus according to the present embodiment determines that the predetermined time has passed after the time at which the event is detected if, for example, a change of the angular velocity or acceleration indicated by the detection data in a set predetermined time is larger than a threshold (or the change is equal to or larger than the threshold). When the predetermined time is adjusted based on detection data as described above, if, for example, user's attention to an object is released by the user's head being moved, a determination is made that the predetermined time has passed after the time at which the event is detected.

If, in step S112, a determination is not made that the predetermined time has passed after the time at which the event is detected, the information processing apparatus according to the present embodiment does not proceed with the processing until a determination is made that the predetermined time has passed after the time at which the event is detected.

If, in step S112, a determination is made that the predetermined time has passed after the time at which the event is detected, the information processing apparatus according to the present embodiment generates Cinemagraph images (processed images according to the present embodiment) (S114).

When the processing in step S114 is performed, the information processing apparatus according to the present embodiment causes the recording medium to record images (S116). Then, the information processing apparatus according to the present embodiment repeats the processing starting with step S102.

The information processing apparatus according to the present embodiment causes the recording medium to record, for example, frame images decided in step S110. The information processing apparatus according to the present embodiment causes the recording medium to record, instead of frame images corresponding to the time at which an event is detected or together with frame images corresponding to the time at which an event is detected, for example, Cinemagraph images (processed images according to the present embodiment) in step S114.

The information processing apparatus according to the present embodiment performs, for example, processing shown in FIG. 11 as processing related to the information processing method according to the present embodiment. For example, the processing (recording control processing) in (1) is realized by the processing shown in FIG. 11. Thus, for example, by the processing shown in FIG. 11 being performed, the information processing apparatus according to the present embodiment can cause the recording medium to record easier-to-view images while reducing the amount of information of a moving image (process target image according to the present embodiment) generated by imaging.

However, the processing according to the present embodiment is not limited to the example shown in FIG. 11.

For example, the information processing apparatus according to the present embodiment may not perform the processing in steps S112, S114 shown in FIG. 11. Even if the processing in steps S112, S114 is not performed, the processing (recording control processing) in (1) is realized. Thus, even if the processing in steps S112, S114 is not performed, like a case in which the processing shown in FIG. 11 is performed, the information processing apparatus according to the present embodiment can cause the recording medium to record easier-to-view images while reducing the amount of information of a moving image (process target image according to the present embodiment) generated by imaging.

(Information Processing Apparatus According to the Present Embodiment)

Next, an example of the configuration of an information processing apparatus according to the present embodiment capable of performing the above processing related to the information processing method according to the present embodiment will be described.

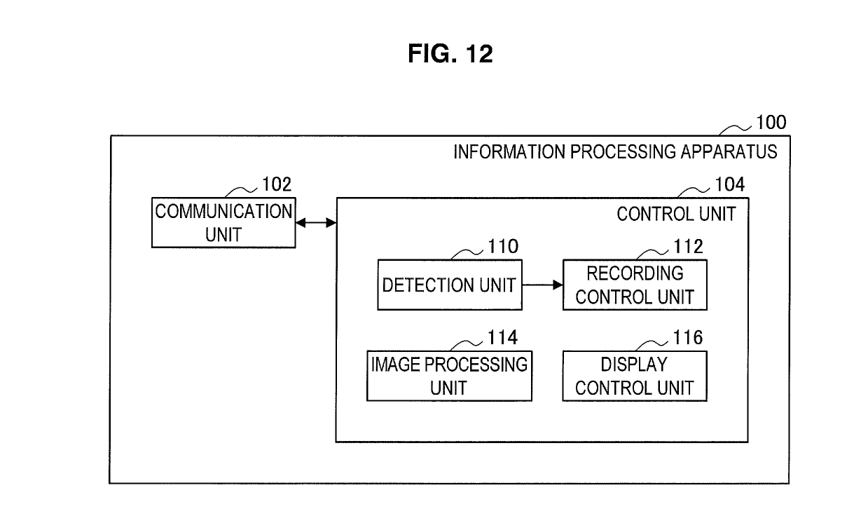

FIG. 12 is a block diagram showing the configuration of an information processing apparatus 100 according to the present embodiment. The information processing apparatus 100 includes, for example, a communication unit 102 and a control unit 104.

The information processing apparatus 100 may also include, for example, a ROM (Read Only Memory, not shown), a RAM (not shown), a storage unit (not shown), an operation unit (not shown) that can be operated by the user, a display unit (not shown) that displays various screens in the display screen and the like. The information processing apparatus 100 connects each of the above elements by, for example, a bus as a transmission path of data.

The ROM (not shown) stores programs used by the control unit 104 and control data of operation parameters and the like. The RAM (not shown) temporarily stores programs executed by the control unit 104.

The storage unit (not shown) is a storage means included in the information processing apparatus 100 and stores various kinds of data, for example, image data showing the process target image and applications. As the storage unit (not shown), for example, a magnetic recording medium such as a hard disk and a nonvolatile memory such as a flash memory can be cited. In addition, the storage unit (not shown) may be removable from the information processing apparatus 100.

As the operation unit (not shown), an operation input device described later can be cited. As the display unit (not shown), a display device described later can be cited.

[Hardware Configuration Example of the Information Processing Apparatus 100]

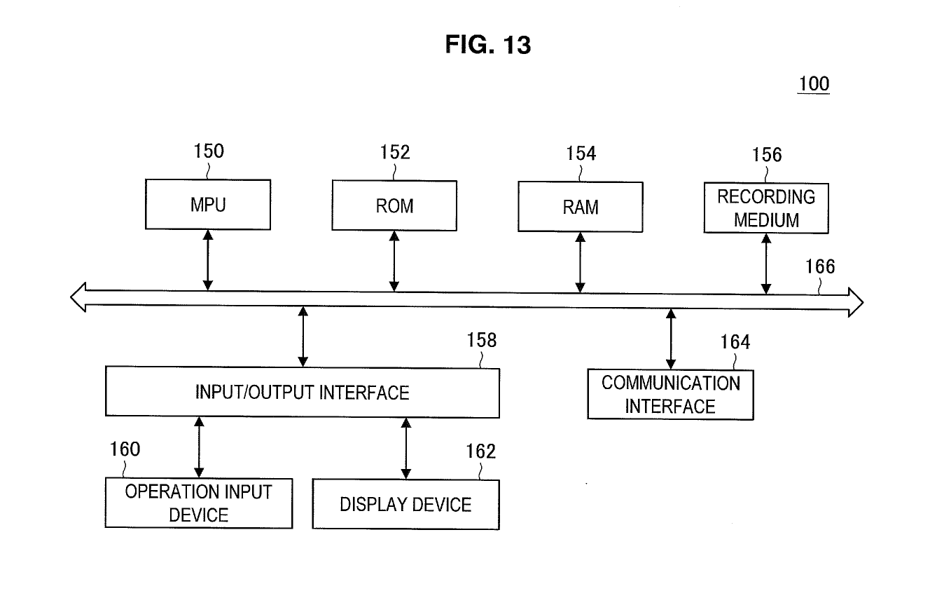

FIG. 13 is an explanatory view showing an example of the hardware configuration of the information processing apparatus 100 according to the present embodiment. The information processing apparatus 100 includes, for example, an MPU 150, a ROM 152, a RAM 154, a recording medium 156, an input/output interface 158, an operation input device 160, a display device 162, and a communication interface 164. The information processing apparatus 100 connects each element by, for example, a bus 166 as a transmission path of data.

The MPU 150 is configured by an MPU (Micro Processing Unit) and various processing circuits and functions as the control unit 104 that controls the whole information processing apparatus 100. The MPU 150 also plays the role of, for example, a detection unit 110, a recording control unit 112, an image processing unit 114, and a display control unit 116 described later in the information processing apparatus 100.

The ROM 152 stores programs used by the MPU 150 and control data of operation parameters and the like. The RAM 154 temporarily stores, for example, programs executed by the MPU 150.

The recording medium 156 functions as a storage unit (not shown) and stores various kinds of data, for example, image data showing the process target image and applications. As the recording medium 156, for example, a magnetic recording medium such as a hard disk and a nonvolatile memory such as a flash memory can be cited. The recording medium 156 may also be removable from the information processing apparatus 100.

The input/output interface 158 connects, for example, the operation input device 160 or the display device 162. The operation input device 160 functions as an operation unit (not shown) and the display device 162 functions as a display unit (not shown). As the input/output interface 158, for example, a USB (Universal Serial Bus) terminal, a DVI (Digital Visual Interface) terminal, an HDMI (High-Definition Multimedia Interface) (registered trademark) terminal, and various processing circuits can be cited. The operation input device 160 is included in, for example, the information processing apparatus 100 and connected to the input/output interface 158 inside the information processing apparatus 100. As the operation input device 160, for example, a button, a direction key, a rotary selector such as a jog dial, or a combination thereof can be cited. The display device 162 is included in, for example, the information processing apparatus 100 and connected to the input/output interface 158 inside the information processing apparatus 100. As the display device 162, for example, a liquid crystal display and an organic electro-luminescence display (also called an OLED display (organic light emitting diode display)) can be cited.

It is needless to say that the input/output interface 158 can also be connected to an external device such as an operation input device (for example, a keyboard, a mouse and the like) and a display device as an external apparatus of the information processing apparatus 100. The display device 162 may be a device capable of the display and user's operations like, for example, a touch screen.

The communication interface 164 is a communication means included in the information processing apparatus 100 and functions as a communication unit 102 that communicates wirelessly or via a cable with an external apparatus such as an external imaging device, an external recording medium, an external display device, an apparatus including an imaging device, an apparatus including a recording medium, and an apparatus including a display device via a network (or directly). As the communication interface 164, for example, a communication antenna, an RF (Radio Frequency) circuit (radio communication), an IEEE802.15.1 port and transmission and reception circuit (radio communication), an IEEE802.11 port and transmission and reception circuit (radio communication), and a LAN (Local Area Network) terminal and transmission and reception circuit (cable communication) can be cited. As networks according to the present embodiment, for example, cable networks such as LAN and WAN (Wide Area Network), wireless networks such as wireless LAN (WLAN: Wireless Local Area Network) and wireless WAN (WWAN: Wireless Wide Area Network) via a base station, and the Internet using a communication protocol such as TCP/IP (Transmission Control Protocol/Internet Protocol).

Based on the configuration shown in, for example, FIG. 13, the information processing apparatus 100 performs processing related to an information processing method according to the present embodiment. However, the hardware configuration of the information processing apparatus 100 according to the present embodiment is not limited to the configuration shown in FIG. 6.

For example, the information processing apparatus 100 may include an imaging device playing the role of an imaging unit (not shown) that captures a moving image. When an imaging device is included, the information processing apparatus 100 can process, for example, captured images generated by imaging using the imaging device as the process target image. As imaging devices according to the present embodiment, for example, a lens/image sensor and a signal processing circuit can be cited.

When the information processing apparatus 100 is configured to perform processing on a standalone basis, the communication interface 164 may not be included. The information processing apparatus 100 may also be configured not to include the recording medium 156, the operation input device 160, or the display device 162.

Referring to FIG. 12 again, an example of the configuration of the information processing apparatus 100 will be described. The communication unit 102 is a communication means included in the information processing apparatus 100 and communicates wirelessly or via a cable with an external apparatus such as an external imaging device, an external recording medium, an external display device, an apparatus including an imaging device, an apparatus including a recording medium, and an apparatus including a display device via a network (or directly). Communication of the communication unit 102 is controlled by, for example, the control unit 104.

As the communication unit 102, for example, a communication antenna, an RF circuit, a LAN terminal and a transmission and reception circuit can be cited, but the configuration of the communication unit 102 is not limited to the above example. For example, the communication unit 102 may be configured to conform to any standard capable of performing communication such as the USB terminal and transmission and reception circuit or may adopt any configuration capable of communicating with an external apparatus via a network.

The control unit 104 is configured by, for example, an MPU and plays the role of controlling the whole information processing apparatus 100. The control unit 104 includes, for example, the detection unit 110, the recording control unit 112, the image processing unit 114, and the display control unit 116 and plays the role of leading processing related to an information processing method according to the present embodiment.

The detection unit 110 plays the role of leading the processing (detection processing) in (3) to detect a corresponding event in the process target image. The detection unit 110 performs, for example, the processing related to the first example shown in (3-1) to the processing related to the fourth example shown in (3-4).

The recording control unit 112 plays the role of leading the processing (recording control processing) in (1) and changes time intervals of frame images the recording medium is caused to record of the process target image based on detection results of an event corresponding to a frame image of the process target image. More specifically, the detection unit 110 decides the recording time of frame images of the process target image the recording medium is caused to record by using, for example, association information according to the present embodiment and causes the recording medium to record frame images corresponding to the decided recording time.

When, for example, an event is detected by the detection unit 110, the recording control unit 112 decides the recording time and causes the recording medium to record frame images corresponding to the decided recording time, but the processing performed by the recording control unit 112 is not limited to the above processing. For example, the recording control unit 112 can also perform the processing (recording control processing) in (1) based on data received by the communication unit 102 and showing results of the processing (detection processing) in (3).

When processed images according to the present embodiment are generated by, for example, the image processing unit 114 described later or an external apparatus, the recording control unit 112 causes the recording medium to record, instead of frame images corresponding to the time at which an event is detected or together with frame images corresponding to the time at which an event is detected, the processed images according to the present embodiment. The recording control unit 112 causes the recording medium to record, for example, processed images according to the present embodiment transferred from the image processing unit 114 or processed images according to the present embodiment received by the communication unit 102.

The image processing unit 114 plays the role of leading the processing (image processing) in (2) and generates processed images (Cinemagraph) according to the present embodiment based on frame images the recording medium is caused to record of the process target image.

The display control unit 116 plays the role of leading the processing (display control processing) in (4) and causes the display screen to display images (frame images or processed images according to the present embodiment) recorded by the recording control unit 112 or the screen related to the images. More specifically, as shown in, for example, the processing according to the first example shown in (4-1), the display control unit 116 causes the display screen to display the time at which an event in the process target image and images (frame images or processed images according to the present embodiment) corresponding to the time at which the event is detected by associating the time and the images. The display control unit 116 also changes, like, for example, the processing according to the second example shown in (4-2), the playback speed of recorded frame images based on a user's operation.

By including, for example, the detection unit 110, the recording control unit 112, the image processing unit 114, and the display control unit 116, the control unit 104 leads processing related to an information processing method according to the present embodiment.

By adopting the configuration shown in, for example, FIG. 12, the information processing apparatus 100 performs processing related to the information processing method according to the present embodiment (for example, “the processing (recording control processing) in (1)” or “two pieces or more of processing including the processing (recording control processing) in (1) from the processing (recording control processing) in (1) to the processing (display control processing) in (4)”).

Therefore, by adopting the configuration shown in, for example, FIG. 12, the information processing apparatus 100 can cause the recording medium to record easier-to-view images while reducing the amount of information of a moving image (process target image according to the present embodiment) generated by imaging.

Also, by adopting the configuration shown in, for example, FIG. 12, the information processing apparatus 100 can cause the recording medium to record, for example, instead of the reference frame image (frame image corresponding to the time at which an event is detected) or together with the reference frame image, processed images according to the present embodiment generated by the processing (image processing) in (2). Therefore, by adopting the configuration shown in, for example, FIG. 12, the information processing apparatus 100 can make, for example, images recorded by Variable Time Lapse images that are well-defined and easier to view by images corresponding to a time around the time at which an event is detected being enhanced in the time direction and the space direction.

Also by adopting the configuration shown in, for example, FIG. 12, the information processing apparatus 100 can perform the processing (display control processing) in (4). Therefore, the information processing apparatus 100 can achieve an effect achieved by the processing (display control processing) in (4) by adopting the configuration shown in, for example, FIG. 12.

However, the configuration of the information processing apparatus 100 is not limited to the configuration shown in FIG. 12.

For example, the information processing apparatus 100 according to the present embodiment can include one or two or more of the detection unit 110, the recording control unit 112, the image processing unit 114, and the display control unit 116 shown in FIG. 12 separately from the control unit 104 (for example, realized by a separate processing circuit).

Also, the information processing apparatus 100 according to the present embodiment can adopt a configuration in which one or two or more of the detection unit 110, the image processing unit 114, and the display control unit 116 shown in FIG. 12 are not included. Even if a configuration not including one or two or more of the detection unit 110, the image processing unit 114, and the display control unit 116 is adopted, the information processing apparatus 100 according to the present embodiment can perform the processing (recording control processing) in (1). Therefore, even if a configuration not including one or two or more of the detection unit 110, the image processing unit 114, and the display control unit 116 is adopted, the information processing apparatus 100 according to the present embodiment can cause the recording medium to record easier-to-view images while reducing the amount of information of a moving image (process target image according to the present embodiment) generated by imaging.

When, for example, the information processing apparatus 100 according to the present embodiment communicates with an external apparatus such as an external imaging device, an external recording medium, an external display device, an apparatus including an imaging device, an apparatus including a recording medium, and an apparatus including a display device via an external communication device, the information processing apparatus 100 may not include the communication unit 102.

In the foregoing, the present embodiment has been described by citing the information processing apparatus, but the present embodiment is not limited to such a form. The present embodiment can be applied to various devices, for example, tablet apparatuses, communication apparatuses such as mobile phones and smartphones, video/music playback apparatuses (or video/music recording and playback apparatuses), game machines, computers such as PCs (Personal Computers) and servers. The present embodiment can also be applied to imaging apparatuses, for example, life log cameras, action cameras for sports, drive recorders, wearable apparatuses (apparatuses worn and used by the user) including an imaging device according to the present embodiment as shown in FIG. 1, and apparatuses including an imaging device according to the present embodiment as shown in FIGS. 2 and 3. The present embodiment can also be applied to, for example, processing IC (Integrated Circuit) that can be embedded in the above devices.

Processing related to an information processing method according to the present embodiment (for example, “the processing (recording control processing) in (1)” or “two pieces or more of processing including the processing (recording control processing) in (1) from the processing (recording control processing) in (1) to the processing (display control processing) in (4)”) may also be realized by a system including a plurality of apparatuses predicated on connection to a network (or communication between apparatuses) like cloud computing.

(Program According to the Present Embodiment)

It becomes possible to cause a recording medium to record easier-to-view images while reducing the amount of information of a moving image generated by imaging by a program (for example, a program capable of performing processing related to an information processing method according to the present embodiment such as “the processing (recording control processing) in (1)” and “two pieces or more of processing including the processing (recording control processing) in (1) from the processing (recording control processing) in (1) to the processing (display control processing) in (4)”) causing a computer to function as an information processing apparatus according to the present embodiment being performed by the computer.

Also, effects achieved by the processing related to an information processing method according to the present embodiment can be achieved by a program causing a computer to function as an information processing apparatus according to the present embodiment being executed by the computer.

The preferred embodiment of the present disclosure has been described above with reference to the appended drawings, but the technical scope of the present disclosure is not limited to the example. A person skilled in the art may find various alterations and modifications within the scope of the appended claims, and it should be understood that they will naturally come under the technical scope of the present disclosure.

While the above shows that, for example, a program (computer program) causing a computer to function as an information processing apparatus according to the present embodiment is provided, according to the present embodiment, a recording medium caused to store the program can also be provided together.

The above configuration shows an example of the present embodiment and naturally comes under the technical scope of the present disclosure.

(1) An information processing apparatus including:

a recording control unit that changes time intervals of frame images in a process target image, the frame images being to be recorded, on the basis of detection results of events corresponding to the frame images, which are images corresponding to respective frames of the process target image, which is a moving image generated by imaging.

(2) The information processing apparatus according to (1), wherein the recording control unit decides a recording time at which the frame images in the process target image are caused to be recorded by setting, as a reference time, a time at which the corresponding event in the process target image is detected, and causes the recording medium to record the frame images corresponding to the decided recording time.
(3) The information processing apparatus according to (2), wherein the recording control unit decides the recording time on the basis of association information in which an actual time based on the reference time and the recording time are associated.
(4) The information processing apparatus according to any one of (1) to (3), further including:

an image processing unit that generates processed images in which a portion of the frame images corresponding to a time at which the event is detected is represented as a moving image on the basis of the frame images the recording medium is caused to record in the process target image.

(5) The information processing apparatus according to (4), wherein when the processed images are generated, the recording control unit causes the recording medium to record the processed images, instead of the frame images corresponding to the time at which the event is detected or together with the frame images corresponding to the time at which the event is detected.
(6) The information processing apparatus according to (5), further including:

a display control unit that causes a display screen to display the time at which the event in the process target image is detected, in association with the processed images corresponding to the time at which the event is detected.

(7) The information processing apparatus according to any one of (1) to (6), further including:

a detection unit that detects the corresponding event in the process target image, wherein the recording control unit changes the time intervals of the frame images in the process target image, the frame images being to be recorded, on the basis of detection results of the event detected by the detection unit.

(8) The information processing apparatus according to any one of (1) to (7), further including:

a display control unit that changes a playback speed of the recorded frame images on the basis of a user's operation.

(9) The information processing apparatus according to any one of (1) to (8), wherein the information processing apparatus is a wearable apparatus worn and used by a user.
(10) An information processing method including:

changing time intervals of frame images in a process target image, the frame images being to be recorded, on the basis of detection results of events corresponding to the frame images, which are images corresponding to respective frames of the process target image, which is a moving image generated by imaging.

(11) A program for causing a computer to execute:

changing time intervals of frame images in a process target image, the frame images being to be recorded, on the basis of detection results of events corresponding to the frame images, which are images corresponding to respective frames of the process target image, which is a moving image generated by imaging.

What is claimed is:

1. An information processing apparatus comprising:
a recording control unit that changes time intervals of frame images in a process target image, the frame images being to be recorded, on the basis of detection results of events corresponding to the frame images, which are images corresponding to respective frames of the process target image, which is a moving image generated by imaging.

2. The information processing apparatus according to claim 1, wherein the recording control unit
decides a recording time at which the frame images in the process target image are caused to be recorded by setting, as a reference time, a time at which the corresponding event in the process target image is detected, and
causes the recording medium to record the frame images corresponding to the decided recording time.

3. The information processing apparatus according to claim 2, wherein the recording control unit decides the recording time on the basis of association information in which an actual time based on the reference time and the recording time are associated.

4. The information processing apparatus according to claim 1, further comprising:
an image processing unit that generates processed images in which a portion of the frame images corresponding to a time at which the event is detected is represented as a moving image on the basis of the frame images the recording medium is caused to record in the process target image.

5. The information processing apparatus according to claim 4, wherein when the processed images are generated, the recording control unit causes the recording medium to record the processed images, instead of the frame images corresponding to the time at which the event is detected or together with the frame images corresponding to the time at which the event is detected.

6. The information processing apparatus according to claim 5, further comprising:
a display control unit that causes a display screen to display the time at which the event in the process target image is detected, in association with the processed images corresponding to the time at which the event is detected.

7. The information processing apparatus according to claim 1, further comprising:
a detection unit that detects the corresponding event in the process target image, wherein
the recording control unit changes the time intervals of the frame images in the process target image, the frame images being to be recorded, on the basis of detection results of the event detected by the detection unit.

8. The information processing apparatus according to claim 1, further comprising:
a display control unit that changes a playback speed of the recorded frame images on the basis of a user's operation.

9. An information processing method comprising:
changing time intervals of frame images in a process target image, the frame images being to be recorded, on the basis of detection results of events corresponding to the frame images, which are images corresponding to respective frames of the process target image, which is a moving image generated by imaging.

10. A program for causing a computer to execute:
changing time intervals of frame images in a process target image, the frame images being to be recorded, on the basis of detection results of events corresponding to the frame images, which are images corresponding to respective frames of the process target image, which is a moving image generated by imaging.
